(19) United States
(12) Patent Application Publication
(10) Pub. No.: US 2008/0169190 A1
(43) Pub. Date: Jul. 17, 2008

(54) NOx gas sensor for automotive exhaust and air pollution monitoring

(75) Inventors: Raju A. Raghurama, Banaglore (IN); Ramsesh Anilkumar, Bangalore (IN)

Correspondence Address: Attorney, Intellectual Property;Honeywell International Inc., 101 Columbia Rd., P.O. Box 2245, Morristown, NJ, 07962, US

(73) Assignee: Honeywell International Inc.

(21) Appl. No.: 11/653,758

(22) Filed: Jan. 12, 2007

(51) Int. Cl. G01N 27/26; B05D 5/12

(52) U.S. Cl. 204/400; 427/58; 427/126.3

(57) ABSTRACT

A NOₓ gas sensor for measuring NO, NO₂ and NOₓ gas content from automotive exhaust including a method for producing such a gas sensor. The NOₓ gas sensor generally includes a substrate, and a plurality of electrodes preformed and located on one side of the substrate. A platinum heater is located the other and opposite side of the substrate. A coating of nano-crystalline powders of a semi-conducting oxide material can be located and configured on the plurality of electrodes preformed on the substrate, thereby forming a gas sensor for the detection of NOₓ. The substrate may be composed of a ceramic material, glass, alumina and/or another type of high-melting material. The electrodes, along with the heater are preferably composed of platinum. The semi-conducting oxide material preferably comprises YMnO₃ or doped YMnO₃.

### TECHNICAL FIELD

Embodiments are generally related to gas sensors. Embodiments are also related to NOₓ gas sensors. Embodiments are also related to techniques for measuring NOₓ gas content from automotive exhaust in high temperature harsh environments. Embodiments are also related to techniques for measuring NO, NO₂ and NOₓ gas during air quality monitoring.

### BACKGROUND OF THE INVENTION

Environmental pollution, such as air pollution, is a serious problem that is particularly acute in urban areas. Much of this pollution is produced by exhaust emissions from motor vehicles. Governmental standards have been set for regulating the allowable amounts of certain pollutants in automobile exhausts. Additionally, in many geographic areas, periodic inspections are required in order to ensure that vehicles meet these standards. The ability to measure exhaust pollutants during a realistic operating period of a vehicle is a growing need in light of recent efforts to regulate and stem the flow of automotive exhaust pollution.

NOₓ gases, which are present in automotive exhaust pollution, are known to cause various environmental problems such as smog and acid rain. The term NOₓ actually refers to several forms of nitrogen oxides such as NO (nitric oxide), NO₂ (nitrogen-di-oxide) and/or N₂O (nitrous oxide). An NOₓ sensor is one solution for detecting NOₓ gases. A NOₓ sensor is typically implemented as a high temperature device that detects nitrogen oxides in combustion environments, such as automobile or truck tailpipes or in factory smokestacks or air pollution in ambient air or cabin air quality.

The main problems that have limited the development of a successful NOₓ sensor (which are often composed of many sensors) are: selectivity, sensitivity, stability, reproducibility, response time, along with detection limitations and cost issues. Additionally, due to the harsh environment of combustion, a high gas flow rate can cool the sensor, which alters the signal or de-laminates the electrodes over time. Soot particles can also degrade the sensor materials. A NOₓ sensor should be stable at a temperature of approximately 900° C. and should constantly withstand harsh environments, particulate matter, unburnt hydrocarbons, carbon monoxide, nitrogen, oxygen and water vapor exposures. The sensitivity to NOₓ of such a sensor should also be great in comparison to other gases and should ideally demonstrate response and recovery times below one second.

Solid-state metal oxide sensors are widely regarded as a low-cost option for exhaust sensors, but offer questionable performance characteristics. Recent development work has significantly improved the performance of solid-state sensors, without increasing the sensor cost. Most semiconductor metal oxides undergo surface interactions, such as physisorption and chemisorption, with gas molecules at elevated temperatures (e.g., 300° C.-600° C.). Because most semiconductor sensors are polycrystalline-composed of multiple crystallite grains pressed or sintered into a continuous structure incorporating grain boundaries, the adsorbed gases have significant electronic effects on the individual crystalline particles.

These gas-solid interactions result in a change in electron or hole density at the surface, forming a space charge, which in turn results in a change in overall conductivity of the semiconductor oxide. This sensing mechanism, however, also tends to result in poor selectivity and excessive baseline drift. Modification of the sensor materials and processing methods can significantly reduce these problems. The careful selection of sensing materials is critical for improving sensor performance. Recently, substantial performance increases have occurred in semi-conducting metal oxide sensors when grain sizes are reduced to the nanoscale level.

The role of gases and the measurement of the concentration have always received wide spread applications in many fields of science and technology. In nano-sized materials, the surface-to-bulk ratio is much greater than for coarse materials, so that the surface properties become paramount, which makes them particularly appealing in applications where such properties are exploited, as in gas sensors. Grain size reduction is one of the main factors enhancing the gas sensing properties of semi conducting oxides and indeed sharp increases in sensitivity are to be expected when the grain size becomes smaller than the space-charge depth according to currently-accepted mechanisms. Thus, the application of nano-structured materials, both as powders and thin films, in gas sensors is rapidly arousing the scientific community interest.

In an effort to address the foregoing difficulties, it is believed that nanocrystalline yttrium manganese oxide (YMnO₃) can be used as a sensing element whose conductivity is very stable in reducing atmospheres for long exposures, while maintaining a melting point is above 1600° C. It is believed that nano-crystalline powders of material such as YMnO₃ can be employed for configuring thin films on platinum comb type electrodes preformed on aluminium substrates as described in greater detail herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved gas sensor.

It is another aspect of the present invention to provide for an NOₓ gas sensor configured using nanocrystalline Yttrium Manganese Oxide (YMnO₃) and doped Y₁₋ₓ RₓMn_{1-y} T_{y}O₃ (where R and T represent rare-earth metals and transition metals respectively and x and y values ranging from 0 to 0.4) a sensing component.

It is another aspect of the present invention to provide for a method for measuring NOₓ gas content from automotive exhaust in high temperature harsh environments.

It is another aspect of the present invention to provide for a method for NO, NO₂ and NOₓ gas content measuring for pollution control in ambient as well as cabin air quality environments.

The aforementioned aspects and other objectives and advantages can now be achieved as described herein. An NOₓ gas sensor for measuring NOₓ gas content from automotive exhaust is described herein. Such a sensor can be located in the exhaust system of an automotive internal combustion engine. Also disclosed is a method for producing such a gas sensor.

The NOₓ gas sensor apparatus generally includes a substrate, and a plurality of electrodes preformed and located on one side of the substrate. A platinum heater is generally located the other and opposite side of the substrate. A coating of nano-crystalline powders of a semi-conducting oxide material located and configured on the plurality of electrodes preformed on the substrate, thereby forming a gas sensor for the detection of NOₓ. The substrate may comprise a ceramic material, glass, alumina and/or another type of high-melting material. The electrodes, along with the heater are preferably composed of platinum. The semi-conducting oxide material preferably YMnO₃.

YMnO₃ and doped Y₁₋ₓ RₓMn_{1-y} T_{y}O₃ compounds can provide a semi conducting oxide material in which conductivity is very stable in reducing atmospheres for long exposures. Additionally, the melting point of YMnO₃ is above a temperature of 1600° C. The NOₓ gas sensor operates based on the electrophillic absorption of NOₓ gas in which the change in conductivity is measured and the NOₓ gas sensor calibrated with known concentrations. Harsh gases such as CO and hydrocarbons will burn off very fast on the surface of the NOₓ gas sensor at and above 800° C. NOₓ diffuses into the sensor film to provide enhanced sensitivity. A catalytic mesh can be provided to prevent the CO and hydrocarbons from entering into the NOₓ gas sensor and avoiding cross-sensitivity and interference from other gases.

The NOₓ gas sensor described herein is very simple to fabricate and possesses a fast response and recovery time for the NOₓ gas because of the nano-size particles employed for this purpose. YMnO₃ can be synthesized with various dopants such as lanthanum, cobalt, chromium, copper and nickel by employing a Sol-Gel process to produce the nano-sized powders along with permitting the fabrication of thin and thick films by electrophoretic deposition, dip coating and also RF magnetron sputtering on preformed platinum electrodes and a platinum heater on the ceramic substrate.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a gas sensor testing apparatus, which can be implemented in accordance with a preferred embodiment;

FIG. 2 illustrates a side view of YMnO₃ and doped YMnO₃ NOₓ gas sensor elements, which can be implemented in accordance with a preferred embodiment;

FIG. 3A illustrates a front view of YMnO₃ NOₓ gas sensor element showing YMnO₃ coating, in accordance with a preferred embodiment;

FIG. 3B illustrates a back view of YMnO₃ NOₓ gas sensor element showing platinum heaters, in accordance with a preferred embodiment;

FIG. 4 illustrates YMnO₃ NOₓ gas sensor interaction with NOₓ gas which can be implemented, in accordance with an alternative embodiment;

FIG. 5 illustrates a flowchart of operations depicting logical operational steps for the preparation of nanocrystalline YMnO₃ coating, in accordance with a preferred embodiment;

FIG. 6 illustrates a flowchart of operations depicting logical operational steps for the detection of NOₓ gases using YMnO₃ NOₓ gas sensor, in accordance with a preferred embodiment; and

FIG. 7 illustrates a side view of a sensor, which can be implemented in accordance with an alternative embodiment.

### DETAILED DESCRIPTION

The particular values and configurations discussed in these non-limiting examples can be varied and are cited merely to illustrate at least one embodiment and are not intended to limit the scope thereof.

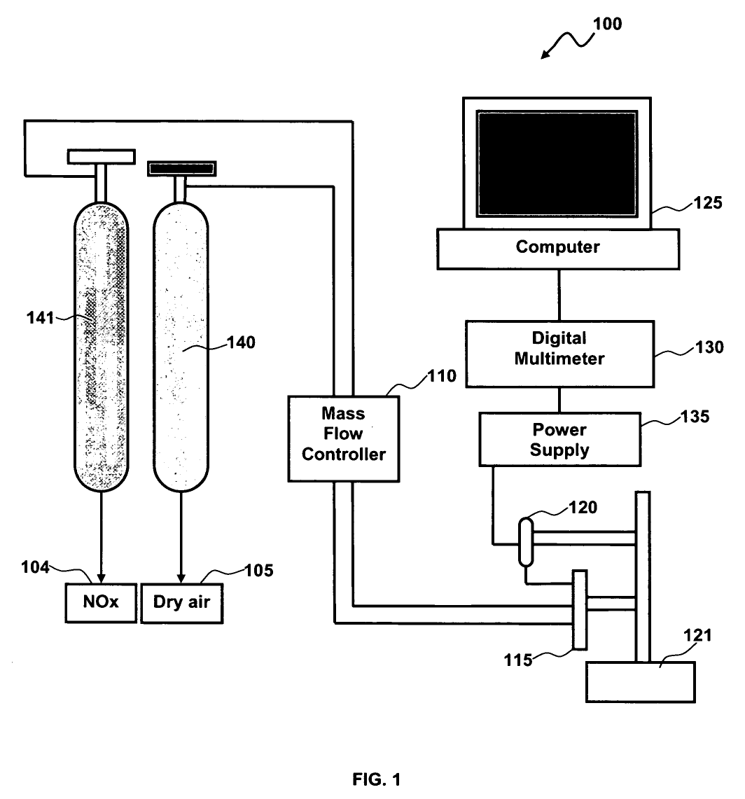

Referring to FIG. 1 a gas sensor testing apparatus 100 is illustrated, which can be implemented in accordance with a preferred embodiment. The gas sensor apparatus 100 generally includes one or more gas tanks 140, 141. The gas tanks 140 and 141 are each connected to a mass flow controller 110, which in turn is connected to a two-way gas valve 115. A holder 121 can be used to hold the two-way gas valve 115 and a sensor 120. The apparatus 100 also includes a computer 125 that is electrically connected to a digital multimeter 130, which in turn is electrically connected to a power supply 135.

The gases, for example, NO, NO₂ or NOₓ gas 104 and/or dry air 105, are delivered by the gas tanks 141 and/or 140, which is then passed through the mass flow controller 110. By adjusting the flow rate of gas using the mass flow controller 110, the concentration of NOₓ gas 104 and dry air 105 can be varied. Similarly, by adjusting the two way gas valve 115, the NOₓ gas 104 and/or dry air 105 can flow to the sensor 120, which functions as a NOₓ sensor, which detects the gas content. Current voltage properties can be measured using the high voltage source or power supply 135 in association with the digital multimeter 130 and the computer 125. The conductance of the NOₓ sensor 120 can be measured using the digital multimeter 130. The change in resistance and relative work function can be simultaneously monitored by the digital multimeter 130. The control computer 125 is generally operable to control and manage the overall operation of the testing apparatus 100. Note that the sensitivity of the gas sensor 120 can be defined as the ratio of the resistance of a sensor element of gas sensor 120 in air with respect to the resistance of the sensor element in the test gas atmosphere as indicated by the following equation (1):

S=Rₐᵢᵣ/R_{gas} (1)

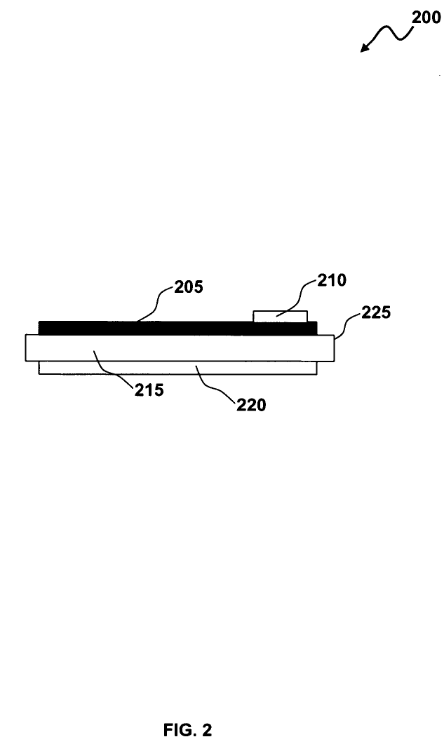

Referring to FIG. 2, a side view of a YMnO₃, NOₓ gas sensor element 200 is illustrated, which can be implemented in accordance with a preferred embodiment. Note that the gas sensor element 200 depicted in FIG. 2 can be adapted for use with the gas sensor 120 illustrated in FIG. 1. The gas sensor element 200 generally includes a substrate 215, which is preferably provided in the form of an alumina ceramic substrate. A plurality of electrodes 205 are disposed on one side of the substrate 215 while a platinum heater 220 can be configured on the other side of the substrate 215 and opposite the electrodes 205.

The gas sensor element 220 functions based on the changes of an oxide film resistance resulting from physisorption, chemisorption and catalytic reactions of the gases in the surface of the film. The electrodes 205 are preferably configured as an arrangement of interdigital comb type platinum electrodes 205 formed on one side of the alumina ceramic substrate 215. On the other side of the sensor element 200, the platinum heater 220 is provided to maintain the sensor element 200 at high temperatures. YMnO₃ can be synthesized with various dopants like lanthanum, cobalt, chromium, copper and nickel by employing a Sol-Gel process to configure nano-size powders and to fabricate thin and thick films by electrophoretic deposition, dip coating, RF magnetron sputtering on the preformed platinum electrodes 205 and the platinum heater 220 on the alumina ceramic substrate 215. A semi-conducting material 210 can also be configured upon the electrodes 205. Note that material 210 can be, for example, YMnO₃.

A Sol-Gel operation or a co-precipitation technique can be utilized to easily control the film structure and introduction of dopants by changing the composition of solution and has a low process cost than other techniques. A sintering operation can be carried out to enhance the adherence of these films to the alumina ceramic substrate 215. Ceramic substrates that can be used may typically select from alumina, zirconia, metal silicates or phosphates or glasses. The gases are absorbed onto the sensor surface 225 and depending on the nature of their interaction electrons, can be trapped or released into the bulk. Changes in the ambient atmosphere are generally reflected in changes in the resistance of the sensor element 200.

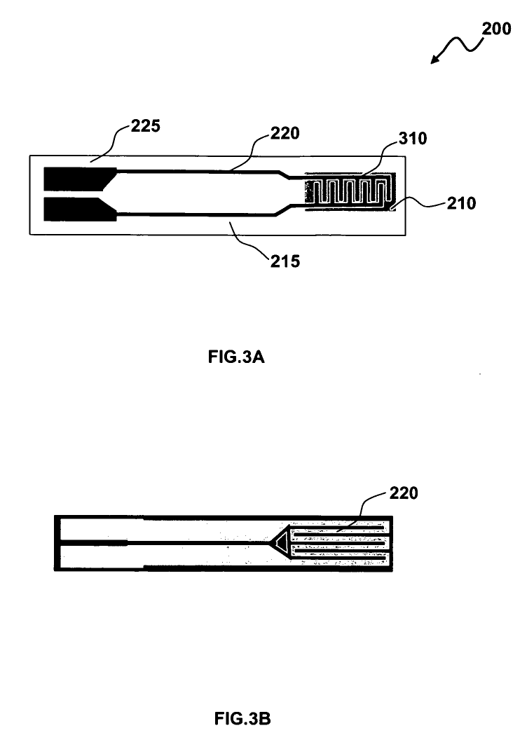

Referring to FIG. 3A, a front view of the YMnO₃ NOₓ gas sensor element 200 depicted in FIG. 2 illustrated, including the depiction of an YMnO₃ coating is illustrated, in accordance with a preferred embodiment. Note that in FIGS. 2 and 3A-3B, identical or similar parts or elements are generally indicated by identical reference numerals. Thus, the sensor platinum electrode 205 can configured with an inter-digital comb structure for maintaining the resistance in an easily measurable range. The sensing mechanism is based on the electrophillic adsorption of NOₓ gas on a semi conducting oxide material 210, such as YMnO₃, The change in conductivity can also be measured and the sensor element 200 calibrated with known concentrations. Harsh gases such as CO and hydrocarbon will burn off very fast on the sensor surface 225 at and above a temperature of 800 C, and NOₓ can diffuse into the film to provide sensitivity to the sensor element 200. Selectivity can thus be achieved with this technique. Additionally, a catalytic mesh 310 can be provided to prevent CO and HC from entering into the sensor element 200 and also to avoid cross-sensitivity and interference from other gases.

Referring to FIG. 3B, a back view of the YMnO₃ NOₓ gas sensor element 200 depicted in FIG. 2 illustrated, including a depiction of the platinum heater 220, in accordance with a preferred embodiment. As indicated in FIG. 3B, the back side of the substrate 215 provides the platinum heater 220, which maintains the sensor element 200 at an appropriate operating temperature. A chemical reaction occurs when combustible gas reaches the sensing element 200. This configuration increases the temperature of the element 200, which is transmitted to the platinum heater 220. The platinum heater 220 is used to regulate the temperature of the sensor element 200, because the finished sensor 120 may exhibit different gas response characteristics at different temperature ranges. Such a heating element (i.e., platinum heater 220) can be a platinum or platinum alloy wire, a resistive metal oxide, or a thin layer of deposited platinum.

The sensor element 200 can be then processed at a specific high temperature, which determines the specific characteristics of the finished sensor element 200 and hence the gas sensor 120 depicted in FIG. 1. In the presence of gas, the metal oxide causes the gas to dissociate into charged ions or complexes which results in the transfer of electrons. The built-in platinum heater 220, which heats the metal oxide material to an operational temperature range that is optimal for the gas to be detected, can be regulated and controlled by a specific circuit, such as, for example, the digital multimeter 130 in association with the power supply 135 and computer 135 depicted in FIG. 1.

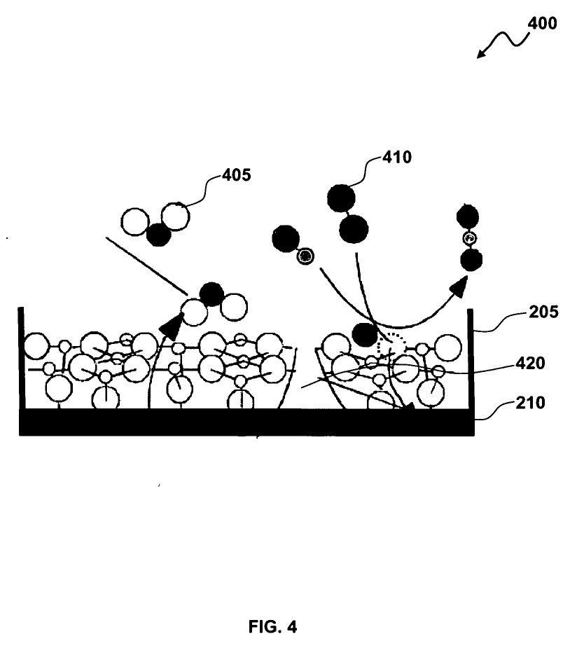

Referring to FIG. 4, a graphical representation 400 of the interaction of an YMnO₃ NOₓ gas sensor such as gas sensor element 200 with NOₓ gas is illustrated, in accordance with an alternative embodiment. Gases in the atmosphere interact with the YMnO₃ coating 210 applied on the platinum electrodes 205. The gases 405 depicted in FIG. 400 are absorbed onto the sensor surface 225 and depending on the nature of their interaction electrons, are trapped or released into bulk. Changes in the ambient atmosphere results in the changes in the resistance of the sensor element 200. The measured conductivity is a combination of a conductivity contribution of the surface 225 which is affected by the NOₓ gas 410 and a conductivity contribution of the bulk which is typically unaffected at the operating temperature of the sensor element 200. The semi conducting oxide material YMnO3 210 is nanocrystalline-composed of multiple crystallite grains pressed or sintered into a continuous structure incorporating grain boundaries 420. The adsorbed gases have significant electronic effects on the individual crystalline particles. In nanocrystalline materials, grain boundaries 420 typically contribute most of the resistance, and conduction relates directly to the height of the energy barrier established at the grain boundary 420 due to the conduction band bending into the space charge layer. Small grain size significantly increases the concentration of grain boundaries 420, which in turn increases sensitivity to changes in the gaseous environment

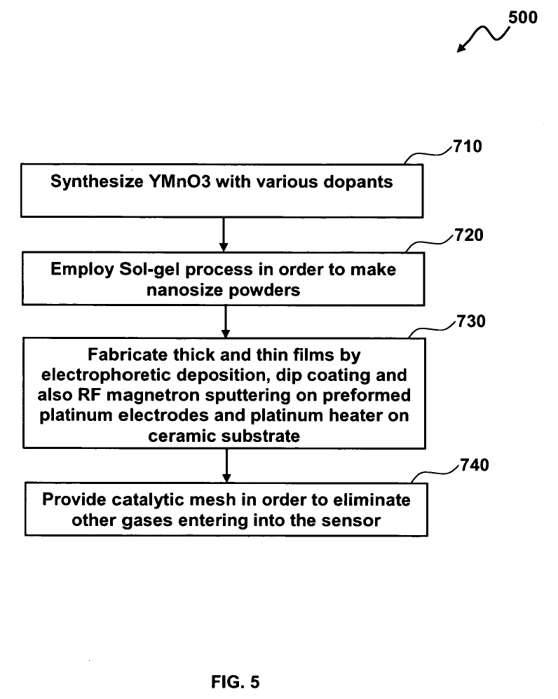

Referring to FIG. 5, a high-level flowchart of operations depicting logical operational steps of a method 500 for the preparation of a nanocrystalline YMnO₃ coating is illustrated, in accordance with a preferred embodiment. YMnO₃ can be synthesized with various dopants, as depicted at block 510. A Sol-Gel process can be employed in order to configure nano size powders, as illustrated at block 520. Thereafter, as depicted at block 530, thick and thin films can be fabricated by electrophoretic deposition, dip coating and also RF magnetron sputtering on preformed platinum electrodes and other platinum heater on ceramic substrates. Next, as indicated at block 540, a catalytic mesh can be provided in order to eliminate other gases entering into the sensor element 200.

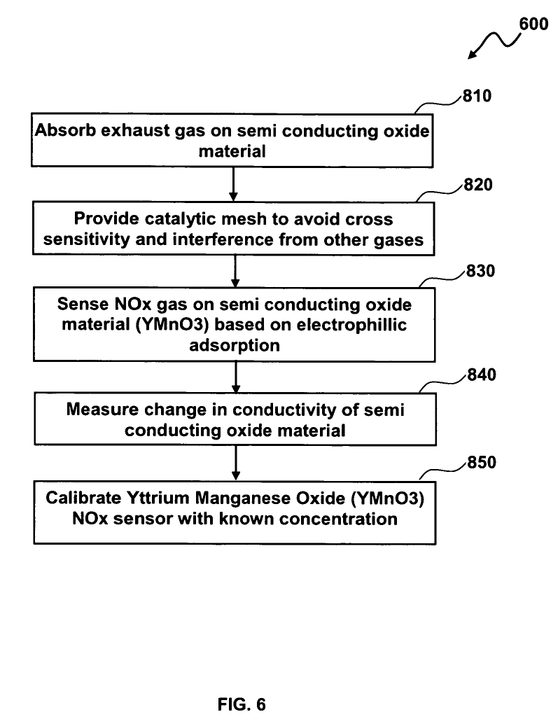

Referring to FIG. 6, a high-level flowchart of operations depicting logical operational steps of a method 600 for the detection of NOₓ gases using a YMnO₃ NOₓ gas sensor is illustrated, in accordance with a preferred embodiment. The methodology depicted in FIG. 6 can be implemented in addition to the method 500 illustrated in FIG. 5. Thus, the method 600 of FIG. 6 complements the operational steps of method 500 depicted in FIG. 5. As indicated at block 610, automotive exhaust gas can be absorbed onto a semi conducting oxide material. A catalytic mesh can be provided in order to avoid cross sensitivity and interference from other gases, as illustrated at block 620. Next, as depicted at block 630, NOₓ gas can be sensed on the semi conducting oxide material (YMnO₃) based on electrophillic adsorption. Thereafter, as depicted at block 640, the change in the conductivity of the semi conducting oxide material can be measured. An yttrium manganese oxide (YMnO₃) NOₓ sensor (e.g., sensor element 200 /sensor 120) can then be calibrated with known concentration, as illustrated at block 650.

The sensor described herein is relatively simple to fabricate and possesses a fast response and recovery for the NOₓ gas because of the nano-sized particles employed for this purpose. Due to a large surface area and the reactive nature of nano-crystalline powders, such benefits can be achieved. The electronics used to measure conductivity change are much simpler in nature and cost less compared to that of electro-chemical and high-conducting materials.

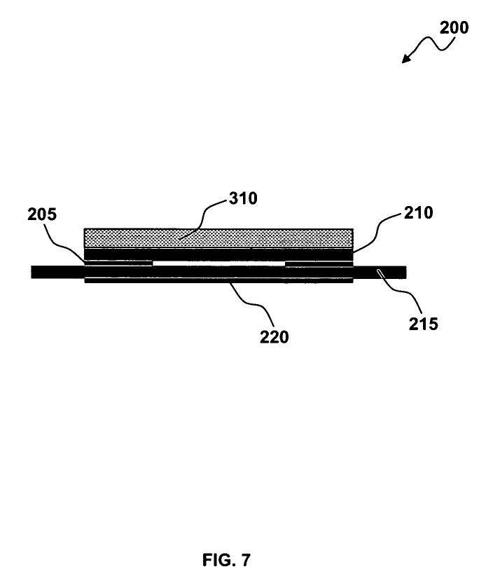

Referring to FIG. 7 a side view of a sensor element 200 is illustrated, which can be implemented in accordance with an alternative embodiment. Sensor 200 generally includes a thick platinum film heater 220 formed in association with a substrate 215, which can be configured from alumina or ceramic. An inter-digital comb of electrodes 205 can be formed on one side of the alumina or ceramic substrate 215. Electrodes 205 can be formed from platinum. A thick film of sensing element Y₁₋ₓ RₓMn_{1-y} T_{y}O₃ 210 can be fabricated on the electrodes 205 by electrophoresis or screen printing, depending upon design considerations. A thick film of catalyst material 310 can be fabricated on the sensing element 210 (i.e., Y₁₋ₓ RₓMn_{1-y} T_{y}O₃). On the other side of the sensor element 200, the platinum film heater 220 can be provided to maintain the sensor element 200 at high temperatures. The configuration of sensor 200 generally permits a catalyst material 310 or a combination of catalysts (e.g., WO₃, MoO₃, XWO₄, X₃WO₅, X₃W₂O₉ (x=Ca, Ba, Sr), Y₂MoO₄, Y₂MoO₅, Y₃Mo₃O₉ (Y=Ca, Ba, Sr), to be used to convert the NO to NO₂ and sense the NOx gas of any combination of NO and NO₂ and to provide the same output.

Based on the foregoing, it can be appreciated that an NOₓ gas sensor apparatus can be implemented, which includes a substrate and a plurality of electrodes pre-formed and located on one side of the substrate. A platinum heater can be located on another and opposite side of the substrate. A coating of nano-crystalline powders of a semi-conducting oxide material can then be located and configured on electrodes pre-formed on the substrate, thereby forming a gas sensor for the detection of gases selected from a group comprising NO, NO₂ and/or NOₓ. The coating of nano-crystalline Yttrium Manganese Oxide (YMnO₃) can be provided by Y1₋ₓ RₓMn_{1-y} T_{y}O₃, wherein the variables R and T respectively represent rare-earth metals and transition metals and the x and y values range from 0 to 0.4. The substrate may comprise a ceramic material selected from the group comprising of alumina, zirconia, metal silicates, glass and metal phosphates. The ceramic material can comprise a material that has a melting point in a range between about 1000° C. and about 2000° C. The semi-conducting oxide material can comprise nano-crystalline Yttrium Manganese Oxide (YMnO₃) and doped Y₁₋ₓ RₓMn_{1-y} T_{y}O₃ (where R and T represent rare-earth metals and transition metals respectively and x and y values ranging from 0 to 0.4).

Additionally, coating of nano-crystalline powders of the semi-conducting oxide material can be located and configured on the plurality of electrodes pre-formed on the substrate by: (a) synthesizing the semi-conducting oxide material with a plurality of dopants by employing a sol-gel process in order to provide a plurality of nano-sized powders; (b) fabricating a thick and a thin film by an electrophoretic deposition, dip coating and RF magnetron sputtering on the plurality of electrodes and the platinum heater; and (c) providing a catalytic mesh in order to eliminate a plurality of gases other than NOₓ from entering into the gas sensor.

A catalyst material can be provided in order to convert NO to NO₂ and thereby detect NOₓ gas for any combination of NO and NO₂ by the YMnO₃ or doped YMnO₃ NOₓ gas sensor and provide a same output thereof. Additionally, two similar YMnO3 sensor elements can be mounted in the exhaust environmental compatible metal housing and maintained at two different temperatures to measure the NO and NO₂ gas concentrations by the use of simple algorithms. The sensitivities and the sensing properties for NO and NO₂ are opposite to each other. The sensitivities for NO and NO₂ at different temperatures are different for the same sensing element. Thus, by maintaining the two sensor elements at two different temperatures, the signals generated by each sensor are different. A combination of an NO₂ sensor, which senses only NO₂ and does not sense NO and two YMnO₃ or doped YMnO₃ sensors, can be used detect NO, NO₂ and NOₓ separately.

Additionally, a catalyst material (e.g., WO3, BaO, Ga₂O₃, BaWO₄, CaWO4, Ba₂WO₅, and Ca2WO5) can be provided on top of the NOx gas sensor element in order to convert NO to NO₂ and thereby detect NOx gas for any combination of NO and NO₂ by the YMnO₃ NOₓ gas sensor and provide a same output thereof. The heater described herein can be formed utilizing a screen printing on the substrates following a sintering operation at a temperature of 1200° C.

It will be appreciated that variations of the above disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A NOₓ gas sensor apparatus, comprising;
a substrate;
a plurality of electrodes preformed and located on one side of said substrate;
a platinum heater located on another and opposite side of said substrate; and
a coating of nano-crystalline powders of a semi-conducting oxide material located and configured on said plurality of electrodes preformed on said substrate, thereby forming a gas sensor for the detection of gases selected from a group comprising NO, NO₂ and NOₓ.

2. The apparatus of claim 1 wherein said coating of nano-crystalline powders comprises Yttrium Manganese Oxide (YMnO₃), which is provided by Y₁₋ₓ RₓMn_{1-y} T_{y}O₃, where R and T represent rare-earth metals and transition metals respectively and x and y values range from 0 to 0.4.

3. The apparatus of claim 1 wherein said substrate comprises a ceramic material selected from the group comprising of alumina, zirconia, metal silicates, glass and metal phosphates.

4. The apparatus of claim 1 wherein said substrate comprises a high-melting material that has a melting point in a range between about 1000° C. and about 2000° C.

5. The apparatus of claim 4 wherein said material comprises glass.

6. The apparatus of claim 4 wherein said high-melting material comprises alumina.

7. The apparatus of claim 1 wherein said plurality of electrodes comprises platinum.

8. The apparatus of claim 1 wherein said semi-conducting oxide material comprises nano-crystalline Yttrium Manganese Oxide (YMnO₃) and doped Y₁₋ₓ RₓMn_{1-y} T_{y}O₃, wherein R and T represent rare-earth metals and transition metals respectively and x and y values ranging from 0 to 0.4).

9. A NOₓ gas sensor apparatus, comprising;
a substrate;
a plurality of electrodes preformed and located on one side of said substrate;
a platinum heater located on another and opposite side of said substrate; and
a coating of nano-crystalline powders of a semi-conducting oxide material located and configured on said plurality of electrodes preformed on said substrate, thereby forming a gas sensor for the detection of gases selected from a group comprising NO, NO₂ and NOₓ and wherein said coating of nano-crystalline powders comprises Yttrium Manganese Oxide (YMnO₃), which is provided by Y₁₋ₓ RₓMn_{1-y} T_{y}O₃, where R and T represent rare-earth metals and transition metals respectively and x and y values range from 0 to 0.4.

10. The apparatus of claim 9 wherein said substrate comprises a ceramic material selected from the group comprising of alumina, zirconia, metal silicates, glass and metal phosphates.

11. The apparatus of claim 9 wherein said substrate comprises a high-melting material that has a melting point in a range between about 1000° C. and about 2000° C.

12. A NOₓ gas sensor method, comprising;
providing a substrate;
pre-forming and locating a plurality of electrodes on one side of said substrate;
locating a platinum heater on another and opposite side of said substrate; and
locating and configuring a coating of nano-crystalline powders of a semi-conducting oxide material on said plurality of electrodes pre-formed on said substrate, thereby forming a gas sensor for the detection of gases selected from a group comprising NO, NO₂ and NOₓ.

13. The method of claim 12 wherein said coating of nano-crystalline powders comprises Yttrium Manganese Oxide (YMnO₃), which is provided by Y₁₋ₓ RₓMn_{1-y} T_{y}O₃, where R and T represent rare-earth metals and transition metals respectively and x and y values range from 0 to 0.4.

14. The method of claim 12 wherein said semi-conducting oxide material comprises nano-crystalline Yttrium Manganese Oxide (YMnO₃) and doped Y₁₋ₓ RₓMn_{1-y} T_{y}O₃, wherein R and T represent rare-earth metals and transition metals respectively and x and y values ranging from 0 to 0.4).

15. The method of claim 12 wherein said substrate comprises a ceramic material selected from the group comprising of alumina, zirconia, metal silicates, glass and metal phosphates.

16. The method of claim 12 wherein said substrate comprises a high-melting material that has a melting point in a range between about 1000° C. and about 2000° C.

17. The method of claim 12 wherein locating and configuring a coating of nano-crystalline powders of a semi-conducting oxide material on said plurality of electrodes pre-formed on said substrate, further comprises:
(a) synthesizing said semi-conducting oxide material with a plurality of dopants by employing a sol-gel process in order to provide a plurality of nano-sized powders;
(b) fabricating a thick and a thin film by electrophoretic deposition, dip coating and RF magnetron sputtering on said plurality of electrodes and said platinum heater; and
(c) providing a catalytic mesh in order to eliminate a plurality of gases other than NOₓ from entering into said gas sensor.

18. The method of claim 12 further comprising providing a catalyst material in order to convert NO to NO₂ and thereby detect NOₓ gas for any combination of NO and NO₂ and provide a same output thereof.

19. The method of claim 12 further comprising two similar YMnO₃ sensor elements mounted in an exhaust environmentally-compatible metal housing and maintained at two different temperatures to measure the NO and NO₂ gas concentrations.

20. The method of claim 12 further comprising:
providing a catalyst material above an NOₓ gas sensor element in order to convert NO to NO₂ and thereby detect NOₓ gas for any combination of NO and NO₂ and provide a same output thereof; and
forming said heater utilizing a screen printing on said substrate following a sintering at a temperature of 1200° C.
